(19) United States
(12) Patent Application Publication
(10) Pub. No.: US 2022/0040016 A1
(43) Pub. Date: Feb. 10, 2022

(54) REMOVABLE ELECTRIC PROPULSION SYSTEM FOR A ROLLING OBJECT - SIMULTANEOUS AND COMBINED GRIPPING AND LIFTING OF THE WHEELS IN THE LONGITUDINAL DIRECTION

(71) Applicant: IFP Energies nouvelles, Rueil-Malmaison (FR)

(72) Inventors: Stephane VENTURI, RUEIL-MALMAISON CEDEX (FR); Bertrand LECOINTE, RUEIL-MALMAISON CEDEX (FR)

(21) Appl. No.: 17/380,552

(22) Filed: Jul. 20, 2021

(30) Foreign Application Priority Data
Aug. 4, 2020 (FR) 2008261

(51) Int. Cl. A61G 5/04; A61G 7/08

(52) U.S. Cl. CPC A61G 5/047; A61G 7/08

(57) ABSTRACT

The present invention relates to a removable electric propulsion system (1) for a rolling object, propulsion system (1) comprising a chassis (2) provided with at least one wheel (3) driven by an electric machine, at least one non-driven wheel (4) and at least one means for coupling electric propulsion system (1) to the rolling object. The coupling means comprises at least one means providing combined and simultaneous gripping and lifting of at least one wheel of the rolling object, and the combined and simultaneous gripping and lifting means comprises a frame (23), at least one arm (24) extendable in a longitudinal direction (x) and connected to frame (23), at least one tilt element (22) and at least one push device (20), one among tilt element (22) and push device (20) being connected to said extendable arm (24) and the other to chassis (2), said push device (20) being capable of driving at least one wheel of the rolling object along said longitudinal direction (x) into said at least one tilt element (22), said tilt element (22) being capable of tilting about an axis of substantially transverse direction (21).

The invention also relates to a coupling method and to a device for coupling a propulsion system to the rolling object.

### FIELD OF THE INVENTION

The invention relates to the field of transport of rolling objects, for example rolling beds such as hospital beds, and more specifically wheelchairs.

Moving rolling heavy loads can lead to difficulties for users, in particular if this action is repeated, such as musculoskeletal disorders.

### BACKGROUND OF THE INVENTION

In order to make the movement of rolling heavy loads easier and more ergonomic, it has been considered to equip these heavy loads with electric machines. For example, a first idea has consisted in providing each hospital bed with an electric wheel drive system. Such a solution is expensive because it requires changing or modifying all the beds, which hospitals cannot afford. Furthermore, the drive system and the battery increase the weight of the bed. Therefore, when the battery is discharged, the effort required to move the bed is greater.

Similarly, in the field of logistics or trade, it has been envisaged to make all trolleys electric. Again, such a solution is expensive.

One alternative is to provide a removable propulsion system for rolling objects. Several technical solutions have been considered.

For example, patent application WO-01/85,086 describes a motorized propulsion system for a bed. The propulsion system is configured for coupling to one or more points of the bed. Due to the coupling means provided for this propulsion system, this system cannot be universal and suitable for different rolling objects. Indeed, it cannot be coupled to a rolling object not provided with a coupling part. In addition, for this propulsion system, all the wheels of the rolling object remain in contact with the ground. Therefore, the orientation of the coupled assembly (propulsion system and bed) is more complicated, the frictional forces are high and the motorized wheel requires more power.

Patent application WO-2012/171,079 describes a second propulsion system for a hospital bed. The propulsion system is configured to lift two wheels of the bed. However, the wheel gripping mechanism is complex and bulky: the lateral dimension (direction parallel to the axis of the motorized wheels) is great (greater than the width of the bed wheels) and it can exceed the lateral dimensions of the bed, which may be inconvenient for moving the bed, in particular in a reduced space such as a hospital corridor or lift.

Patent application WO-2013/156,030 describes a third propulsion system for a hospital bed. The propulsion system is configured to lift two wheels of the bed. However, the lifting system requires several actuators. It is therefore complex.

French patent application FR-3,089,786 filed by the applicant is also known. This solution allows to lift the wheels of the rolling object once they are at a 90° angle, in the transverse direction, so as to provide coupling of the rolling bed to the electric propulsion system. However, this system is not suitable for rolling objects provided with non-orientable wheels, such as the rear wheels of wheelchairs.

In order to enable gripping and lifting the wheels of the rolling object in a simple and fast manner, for rolling objects with orientable wheels as well as non-orientable wheels, the present invention relates to a removable electric propulsion system for a rolling object. The propulsion system comprises a chassis provided with at least one wheel driven by an electric machine. The propulsion system further comprises at least one non-driven wheel (preferably two non-driven wheels) and at least one means for coupling the electric propulsion system to the rolling object. Furthermore, the coupling means comprises at least one means for combined and simultaneous gripping and lifting of at least one wheel of the rolling object, and the combined and simultaneous gripping and lifting means comprises a frame, at least one arm extendable in a longitudinal direction and connected to the frame, at least one tilt element and at least one push device, one among the tilt element and the push device being connected to said extendable arm and the other to the frame, the push device being capable of driving at least one wheel of the rolling object along the longitudinal direction into at least one tilt element, the tilt element being capable of tilting about an axis of substantially transverse direction, orthogonal to the longitudinal direction in the horizontal plane.

Therefore, once coupled, the wheels of the rolling object are in the longitudinal direction corresponding to the principal direction of displacement of the electric propulsion system.

### SUMMARY OF THE INVENTION

The invention relates to a removable electric propulsion system for a rolling object, said propulsion system comprising a chassis provided with at least one wheel driven by an electric machine, at least one non-driven wheel and at least one means for coupling said electric propulsion system to said rolling object. Furthermore, said coupling means comprises at least one means for combined and simultaneous gripping and lifting at least one wheel of said rolling object. Besides, said combined and simultaneous gripping and lifting means comprises a frame, at least one arm extendable in a longitudinal direction and connected to the frame, at least one tilt element and at least one push device, one among the tilt element and the push device being connected to said extendable arm and the other to the frame, said push device being capable of driving at least one wheel of the rolling object along said longitudinal direction into said at least one tilt element, said tilt element being capable of tilting about an axis of substantially transverse direction.

Preferably, said extendable arm supports at least one of said at least one non-driven wheel.

According to a variant of the invention, said combined and simultaneous gripping and lifting means comprises at least one device for limiting the angular clearance of at least one tilt element.

Advantageously, an approach stop is positioned on said frame or on said tilt element.

According to an embodiment of the invention, said push device comprises at least one transverse-axis roller fastened to said extendable arm or said frame.

Preferably, said push device comprises a first and a second transverse-axis roller fastened to said extendable arm or said frame, said first roller being configured to contact the wheel of the rolling object before the second roller, the altitude of the axis of the first roller being lower than the altitude of the axis of the second roller.

Preferably, the diameter of the first roller is less than the diameter of the second roller.

According to a configuration of the invention, said coupling means is adjustable in longitudinal position along the chassis.

Advantageously, the push device comprises two guide pieces extending substantially in the longitudinal direction, said guide pieces being configured to prevent the wheels of the rolling object from pivoting.

According to an implementation of the invention, at least one tilt element comprises a means for adjusting the width of said tilt element, said means for adjusting the width of said tilt element being preferably a mobile flange or a shim.

Preferably, the electric propulsion system comprises two combined and simultaneous gripping and lifting means, each combined and simultaneous gripping and lifting means being dedicated to a wheel of the rolling object, both combined and simultaneous gripping and lifting means being mobile in transverse translation with respect to one another.

According to an embodiment of the invention, said frame is connected to said chassis by a sliding connection of transverse direction, preferably by an actuator.

According to a variant of the invention, the combined and simultaneous gripping and lifting means comprises a raising device configured to ensure a ground clearance greater than a predetermined height in raised position, preferably the predetermined height ranges between 30 mm and 50 mm, and it is more preferably close to 40 mm.

Preferably, the raising device comprises at least one return spring and/or at least one counterweight and/or at least one driven rod.

Advantageously, a (second) stop is positioned on said frame or on said extendable arm to provide contact of the tilt element in raised position.

The invention also relates to a coupled assembly made up of a rolling object, preferably a rolling object comprising at least one non-orientable wheel, and an electric propulsion system as described above, said rolling object being coupled to said electric propulsion system by said coupling means.

Furthermore, the invention relates to a method for coupling a rolling object to the electric propulsion system as described above, the method comprising the following steps:

a) moving the electric propulsion system so as to bring it close to at least one wheel of the rolling objet,

b) lengthening the extendable arm so as to enable positioning of said at least one wheel of the rolling object between the tilt element and the push device,

c) moving the electric propulsion system in such a way that said at least one wheel of the rolling object is positioned between the tilt element and the push device.

d) shortening the extendable arm in such a way that the push device or the tilt element contacts said at least one wheel of the rolling object,

e) continuing shortening the extendable arm in such a way that the push device drives said at least one wheel of the rolling object into the tilt element.

Preferably, said electric propulsion system comprises two combined and simultaneous gripping and lifting means, and said method comprises at least the following steps:

a) moving the electric propulsion system so as to bring it close to two wheels of the rolling objet,

b) moving transversely at least one of the two combined and simultaneous gripping and lifting means with respect to the other combined and simultaneous gripping and lifting means,

c) lengthening the extendable arm of each combined and simultaneous gripping and lifting means so that the space between the tilt element and the push device allows passage of a wheel of the rolling object,

d) moving transversely at least one of the two combined and simultaneous gripping and lifting means with respect to the other combined and simultaneous gripping and lifting means, in the opposite direction to step b), until each wheel of the rolling object is positioned between a push device and a tilt element,

e) shortening the extendable arms so as to drive each wheel of the rolling object into each tilt element by means of the push device.

### BRIEF DESCRIPTION OF THE FIGURES

Other features and advantages of the system and of the method according to the invention will be clear from reading the description hereafter of embodiments given by way of non-limitative example, with reference to the accompanying figures wherein:

FIG. 1 is a top view of an electric propulsion system according to a first embodiment of the invention,

FIG. 2 is a top view of an electric propulsion system according to a second embodiment of the invention,

FIG. 3 is a side view of an electric propulsion system according to a first variant embodiment of the invention,

FIG. 4 is a side view of an electric propulsion system according to a second variant embodiment of the invention,

FIG. 5 is a top view of the propulsion system coupled to a rolling object according to the invention,

FIG. 6 illustrates the various steps allowing a first variant of a combined and simultaneous gripping and lifting means according to the invention to grip and lift a wheel of the rolling object,

FIG. 7 illustrates the various steps allowing a second variant of a combined and simultaneous gripping and lifting means according to the invention to grip and lift a wheel of the rolling object,

FIG. 8 illustrates the various steps allowing a third variant of a combined and simultaneous gripping and lifting means according to the invention to grip and lift a wheel of the rolling object,

FIG. 9a illustrates a first step of a method for gripping and lifting the wheels of a rolling object from a propulsion system according to the invention.

FIG. 9b illustrates a second step of a method for gripping and lifting the wheels of a rolling object from a propulsion system according to the invention,

FIG. 9c illustrates a third step of a method for gripping and lifting the wheels of a rolling object from a propulsion system according to the invention,

FIG. 9d illustrates a fourth step of a method for gripping and lifting the wheels of a rolling object from a propulsion system according to the invention,

FIG. 9e illustrates a fifth step of a method for gripping and lifting the wheels of a rolling object from a propulsion system according to the invention,

FIG. 9f illustrates a sixth step of a method for gripping and lifting the wheels of a rolling object from a propulsion system according to the invention,

FIG. 9g illustrates a seventh step of a method for gripping and lifting the wheels of a rolling object from a propulsion system according to the invention,

FIG. 10 illustrates another embodiment of the propulsion system of the invention,

FIG. 11a illustrates a configuration of an embodiment of a combined and simultaneous gripping and lifting means of a propulsion system according to the invention, with a raising device, in rest position,

FIG. 11b illustrates a configuration of an embodiment of a combined and simultaneous gripping and lifting means of a propulsion system according to the invention, with a raising device, in rest position shown with dotted lines and in raised position shown in solid line,

FIG. 12 illustrates the force to be applied onto the combined and simultaneous gripping and lifting means and the elevation of the wheel of the rolling object, as a function of the displacement applied, for a first embodiment of the system comprising a single tilter, and

FIG. 13 illustrates the force to be applied onto the combined and simultaneous gripping and lifting means and the elevation of the wheel of the rolling object, as a function of the displacement applied, for a second embodiment of the system comprising a tilter and an angular clearance limiting device.

### DETAILED DESCRIPTION OF THE INVENTION

The invention relates to a removable electric propulsion system for a rolling object. An electric propulsion system is understood to be a removable system for assisting the movement of the rolling object in order to limit the forces required for the displacement of the rolling object. This electric propulsion system comprises at least one electric machine for driving it. A rolling object is an object comprising at least two wheels in order to move it.

The rolling object can have any shape, it can notably be a rolling bed, such as those used in hospitals, a wheelchair, a trolley, such as those used for logistics, hospital logistics or commercial logistics (such as a shopping trolley) for example, any rolling furniture. Such a rolling object comprises at least two wheels, preferably three or four. According to a variant of the invention, at least one wheel, preferably two wheels of the rolling object are idle (or orientable) wheels, in other words, off-centered wheels orientable around a vertical axis. The rolling object is preferably non-motorized.

The electric propulsion system of the invention is particularly suitable for rolling objects having non-orientable wheels, such as the rear wheels of wheelchairs. These non-orientable wheels are advantageously those which are gripped and lifted in the electric propulsion system of the invention.

The electric propulsion system according to the invention comprises:

a chassis provided with at least one motorized wheel, i.e. a wheel driven by an electric machine,

at least one non-motorized wheel, i.e. not driven by an electric machine. This non-motorized wheel can notably be connected to the chassis by means of an extendable arm in the longitudinal direction. Preferably, the system comprises at least two non-motorized wheels,

at least one means for coupling the propulsion system to a rolling object, the coupling means comprising at least one means for combined and simultaneous gripping and lifting of at least one wheel of the rolling object. In other words, the combined and simultaneous gripping and lifting means is configured to simultaneously grip (grab) and lift at least one wheel of the rolling object. A combined and simultaneous gripping and lifting means is understood to be a means allowing to simultaneously grip and lift at least one wheel of the rolling object through a combined action by means of a single actuator. The combined and simultaneous gripping and lifting means thus comprises a single control simultaneously allowing to grip and lift at least one wheel of the rolling object. In other words, such a combined and simultaneous gripping and lifting means differs:
on the one hand, from the gripping and lifting means with two distinct controls: one for gripping and the other for lifting; these means do not enable a combined action through a single common control,
on the other hand, from the gripping and lifting means provided for successive gripping and lifting actions, even momentary.

Using a combined and simultaneous gripping and lifting means is particularly advantageous. Indeed, by means of a combined gripping and lifting action, the kinematics of coupling the rolling object to the propulsion system is simplified. Moreover, this simplification associated with the simultaneity of the gripping and lifting actions allows coupling to be achieved faster than when dissociating these actions, even partly.

Such a combined and simultaneous gripping and lifting means thus enables simple and fast coupling of any rolling object (since no coupling device is required on the rolling object) on the propulsion system. Furthermore, this propulsion system allows to grip and lift orientable wheels as well as non-orientable wheels of rolling objects.

According to the invention, the combined and simultaneous gripping and lifting means comprises a frame, at least one arm extendable in a longitudinal direction and connected to the frame, at least one tilt element and at least one push device. One among the tilt element and the push device is connected to said extendable arm and the other to the frame. For example, the tilt element can be connected to the frame (by a transverse-axis pivot connection for example) and the push device can be connected (fastened for example) to the extendable arm. Alternatively, the tilt element can be connected to the extendable arm (by a transverse-axis pivot connection for example) and the push device can be connected (fastened for example) to the frame.

The push device is capable of driving at least one wheel of the rolling object along the longitudinal direction into the tilt element. When the push device is positioned on the extendable arm, a longitudinal movement of the extendable arm drives the wheel towards, then into the tilt element. When the push device is positioned on the frame, the longitudinal movement of the extendable arm is transmitted to the tilt element. In this case, the push device acts so as to prevent the wheel from continuing its longitudinal movement. Thus, the push device drives (through a force applied by the wheel of the rolling object on the push device) the wheel into the tilt element. Therefore, the tilt element and the push device face one another along a longitudinal direction.

Furthermore, the tilt element is capable of tilting about an axis of substantially transverse direction.

Thus, through a movement of the extendable arm in the longitudinal direction and oriented towards the frame, it is possible to drive the wheel of the rolling object, by means of the push device, into the tilt element. Furthermore, from the contact of the wheel with the tilt element, the continuation of the longitudinal action of the extendable arm allows to grip and to lift the wheel of the rolling object in the tilt element. The tilt element is designed to automatically tilt under the effect of the force of the wheel of the rolling object and of its displacement in the longitudinal direction. The tilt element therefore has no tilt control means.

Besides, the tilt element is connected to the frame or to the extendable arm by a pivot connection in a substantially transverse direction. The tilt element can therefore tilt about this transverse axis when the wheel of the rolling object moves in the longitudinal direction.

The tilt element can notably be a tilter. A tilter according to the invention comprises a two-piece bent part, this bent part being pivotably connected about an axis, preferably of transverse direction, about which it can tilt. The two pieces of the bent part join substantially at the transverse axis used as a pivot. In other words, the bend of the tilter is located at the transverse axis. The wheel of the rolling object first contacts one of the two pieces at a first contact point, it tilts around the first contact point and then contacts a second contact point on the other part of the tilter. The longitudinal displacement of the wheel driven by the push device moves the centre of gravity of the assembly with respect to the transverse pivot axis and causes the assembly to tilt around this pivot axis.

The frame is connected to the chassis by either a fixing device or a sliding connection. Fastening to the chassis can notably be used when a single wheel of the rolling object (a tricycle for example) is to be gripped. The sliding connection provides an improved degree of adaptation of the system allowing two wheels of the rolling object to be gripped.

For example, a motorized wheel can be arranged at one longitudinal end of the chassis and two non-motorized wheels can be arranged at the other longitudinal end of the propulsion system, on the extendable arm, the vertical axis of the motorized wheel being preferably, in top view, on the mid-perpendicular of the vertical axes of the non-motorized wheels in top view. Therefore, the mid-perpendicular of the vertical axes extends in the longitudinal direction of the chassis (and of the propulsion system).

The non-driven wheels of the propulsion system and/or those of the rolling object can comprise orientable off-centered wheels.

Orientable off-centered wheels are understood to be off-centered idle wheels orientable around a vertical axis. In other words, these wheels can pivot with respect to the chassis about a vertical orientation axis, and the orientation axis of the wheel is off-centered (non-concurrent) with respect to the vertical orientation axis. Thus, a movement applied to the chassis tends to orient the wheel in the opposite direction to the displacement caused by the movement applied to the chassis. The wheels therefore orient themselves automatically, thus facilitating the maneuverability of the system.

Non-orientable wheels are understood to be wheels that cannot pivot with respect to the chassis or to the rolling object itself.

Preferably, the electric propulsion system can comprise a handlebar enabling handling, displacement and orientation of the electric propulsion system by a user.

Coupling of the rolling object to the propulsion system is achieved by at least one wheel of the rolling object, which can be an idle wheel (orientable through the effect of the eccentricity of the vertical axis for example) or a non-orientable wheel of the rolling object. Therefore, the rolling object does not need to be adapted for the electric propulsion system, which makes the electric propulsion system universal for various rolling objects. Preferably, coupling of the rolling object to the propulsion system can be achieved by two wheels of the rolling object, which simplifies the coupling method and the associated coupling means.

In the present description, the terms “longitudinal”, “transverse”, “horizontal” and “vertical” determine the axes and/or the directions of the system when the system stands on a flat and level ground (i.e. a non-sloping ground, in other words, there is no altitude difference on the ground) and in an operating position.

The longitudinal direction corresponds to the principal direction of displacement of the electric propulsion system, i.e. that which minimizes the energy required for displacement of the system.

The transverse direction (also referred to as lateral in the rest of the description) is the direction orthogonal to the longitudinal direction of the system in the horizontal plane.

The vertical direction is orthogonal to the horizontal plane of the system.

According to a preferred implementation of the invention, the extendable arm can support at least one non-driven wheel. The position of the non-driven wheel on the extendable arm allows to take part in the taking up of the weight when a rolling object is coupled to the propulsion system. Furthermore, the non-driven wheel can thus be positioned at one longitudinal end of the propulsion system, which allows to improve the maneuverability and to limit the number of wheels necessary for the system.

Preferably, the combined and simultaneous gripping and lifting means can comprise at least one device for limiting the angular clearance of at least one tilt element. The angular clearance limiting device can notably limit the angular clearance of at least one tilt element. Therefore, the force required to initiate gripping and lifting of the wheels of the rolling object can be reduced. In a sense, the angular clearance limiting device acts in a manner similar to the addition of a tilt element in the system. The angular clearance limiting device thus facilitates gripping and initial lifting of the wheel of the rolling object. The angular clearance limiting device also allows to position the lowest point of the tilt element with respect to the ground and thus to define the altitude of the contact between the tilt element and the wheel of the rolling object.

According to an advantageous implementation of the invention, an approach stop can be positioned on the frame or on the tilt element. It can be advantageously fastened to the frame or the tilt element. The approach stop can notably comprise a part in the longitudinal direction erected in the direction of the push device. The purpose of this approach stop is to enable contact between the wheel of the rolling object and the combined and simultaneous gripping and lifting means. It can also allow to stop the transverse displacement of this combined and simultaneous gripping and lifting means when it can move laterally. This approach stop also allows the system to dampen the shock caused by the contact. It can comprise a part made of rubber or of a shock absorber material (elastomer for example).

The contact between the approach stop and the wheel of the rolling object allows to improve positioning of the wheel so as to facilitate gripping and lifting thereof in the electric propulsion system.

Advantageously, the push device can comprise at least one transverse-axis roller fastened to a support connected to the extendable arm or to the frame. For example, the support can be fastened to the extendable arm or to the frame. Alternatively, the support can be connected to the extendable arm or to the frame by a sliding connection of transverse direction. Thus, the roller is substantially in the transverse direction, which allows the wheel of the rolling object to be driven in the longitudinal direction. The roller is intended to provide contact between the push device and the wheel. The push device with at least one roller allows the lifetime of the system to be improved. Positioning the roller on the extendable arm allows the wheel of the rolling object to be driven in the direction of the tilt element through the longitudinal displacement of the extendable arm. Furthermore, when the rolling object is already in contact with the tilt element, the roller serves to create the lifting movement by means of the tilt element.

According to a preferred variant of the invention, the push device can comprise a first and a second transverse-axis roller fastened to a support connected to the extendable arm or to the frame. In other words, the two rollers are parallel to each other. Moreover, the first roller can be configured to come into contact with the wheel of the rolling object before the second roller. In other words, the distance between the tilt element and the first roller is shorter than the distance between the tilt element and the second roller. Furthermore, the altitude of the axis of the first roller can be less than the altitude of the axis of the second roller. Therefore, the first roller serves notably to initiate the push force applied onto the wheel of the rolling object until it comes into contact with the tilt element or to stop the longitudinal displacement of the wheel driven by the tilt element, itself driven by the extendable arm. Thus, this first roller is preferably not positioned too high. Then, when the wheel of the rolling object lifts progressively, the wheel comes progressively into contact with the second roller. Positioning of this second roller constitutes an obstacle that provides retention of the wheel of the rolling object in the tilt element.

According to an advantageous variant of the invention, the diameter of the first roller can be less than that of the second roller. Thus, the first roller having a reduced diameter, the wheel can come into contact with the second roller once it starts lifting. Furthermore, since the diameter of the second roller is greater, it constitutes a better obstacle for holding the wheel of the rolling object in the tilt element.

The embodiments with double rollers provide great adaptability of the system for various rolling object wheel diameters.

According to a configuration of the invention, the coupling means can be adjustable in longitudinal position along the chassis. In other words, the coupling means can be moved longitudinally along the chassis so as to further improve the adaptability of the coupling means to various rolling objects. The coupling means can therefore be connected to the chassis by a sliding connection of longitudinal axis. Longitudinal displacement of the coupling means can be achieved manually and, once the displacement completed, this position can be maintained for example by a pin that may be arranged in various longitudinally distributed orifices. This longitudinal displacement may alternatively be provided by an actuator such as a hydraulic, pneumatic or electric cylinder. Longitudinal adjustment can notably allow to improve the compactness of the assembly and/or to improve the coupling stability, for example for a wheelchair comprising a storage compartment at the rear.

Advantageously, the push device can comprise at least two guide pieces extending substantially in the longitudinal direction. For example, these two guide pieces can be positioned on either side of a roller, the two guide pieces being oriented in the direction of the tilt element. These two guide pieces can be configured to prevent the wheels of the rolling object, when they are orientable, from pivoting when the push device is moving towards the tilt element. Thus, the system facilitates gripping and lifting of orientable wheels of the rolling object in the tilt element.

According to a variant of the invention, at least one tilt element can comprise a means of adjusting the width of the tilt element. Thus, the width of the tilt element can be suited to the width of the wheel of the rolling object. The tilt element with the width adjustment means enables adaptation for simple wheels and dual wheels. Simple wheels consist of a single wheel rotating about a horizontal axis of rotation. Dual wheels consist of two wheels rotating about a single horizontal axis of rotation. The means of adjusting the width of the tilt element allows to improve gripping and lifting of the rolling object wheels, notably when they are orientable, as well as immobilization thereof, the means of adjusting the width of the tilt element allowing the clearance between the rolling object wheel and the tilt element to be limited.

The width of the tilt element is understood to be the distance between the ends of the tilt element, the ends extending along the axis of rotation of the tilt element. For example, when the axis of the tilt element is substantially transverse, the width of the tilt element is the distance, in the transverse direction, between the ends of the tilt element. The width of the tilt element can thus be adapted to the width of the wheel, which may be a simple or a dual wheel.

Alternatively, in the case of non-orientable wheels, a sufficient width can be provided for the tilters to adapt to simple wheels as well as dual wheels. In other words, the width of the tilters is greater than the maximum width of the simple and/or dual wheels of the rolling objects intended to be coupled to the electric propulsion system.

Preferably, the means of adjusting the width of the tilt element can be a mobile flange. A mobile flange is a part, a plate or a piece of a plate for example, translatably mobile in the direction of the axis of the tilt element. Thus, the user can position the flange with the width suited to the wheel of the rolling object.

According to another variant, the means of adjusting the width of the tilt element can be a shim. Therefore, the shim can be set on or removed from the tilt element. A set of shims can be used so as to adapt to various wheel widths of the rolling object. The shim can be removable.

According to a preferred embodiment of the invention, the coupling means can be configured to simultaneously achieve gripping and lifting of at least two wheels of the rolling object. Thus, the system can comprise two combined and simultaneous gripping and lifting means, each being configured to grip and lift a distinct wheel of the rolling object. Furthermore, the two combined and simultaneous gripping and lifting means can be mobile in transverse translation with respect to each other. It is therefore possible to position the tilt elements and the push devices in such a way that each one of the two wheels of the rolling object to be gripped is between a tilt element and a push device.

The two extendable arms of each combined and simultaneous gripping and lifting means can then be actuated by a single controller. In other words, the common controller simultaneously controls two actuators, cylinders for example, allowing each extendable arm to be simultaneously lengthened or shortened.

Alternatively, the system can comprise a combined and simultaneous gripping and lifting means allowing to grip and to lift the two wheels of the rolling object. For example, two push devices can then be connected to a single extendable arm, one at least of the push devices being connected to the extendable arm by a sliding connection in the transverse direction to enable relative spacing or moving together of the two devices in the lateral direction. Similarly, one at least of the two tilt elements is connected by a sliding connection to the frame so as to enable positioning of the two tilt elements opposite the wheels of the rolling object to be gripped.

According to a configuration of the invention, the frame can be connected to the chassis by a sliding connection of transverse direction, for example an actuator such as a hydraulic, electric or pneumatic cylinder. This configuration is particularly advantageous when two wheels of the rolling object are to be gripped and lifted simultaneously. Indeed, the transverse sliding connection allows to move apart or together the tilt elements and the push devices by means of the transverse sliding connection, in order to position them so that the wheels of the rolling object are between the tilt elements and the push devices, thus facilitating the simultaneous and combined operations of gripping and lifting the rolling object wheels. The frames can for example be moved away by means of the transverse sliding connection. The propulsion system is then moved forward and/or the extendable arm is pushed aside so as to move each push device away from the facing tilt element, so as to allow each one of the two wheels of the rolling object to be positioned between the push device and the tilt element of each combined and simultaneous gripping and lifting means. The two frames are subsequently moved closer to one another by means of the transverse sliding connection, so as to position each one of the two wheels of the rolling object to be gripped between a tilt element and the opposite push device.

Preferably, the combined and simultaneous gripping and lifting means can comprise a raising device configured to ensure a ground clearance greater than a predetermined height in raised position. Indeed, in rest position of the combined and simultaneous gripping and lifting means, the rest position being defined by the position of the combined and simultaneous gripping and lifting means free of any movement and therefore supporting no wheel, at least part of the gripping element (the tilt element for example) can be close to the ground to facilitate gripping and lifting of the rolling object wheel. This position is therefore advantageous to facilitate coupling, but it is particularly inconvenient when it is desired to handle the propulsion system without it being coupled to a rolling object, for example when a user utilizes the propulsion system in scooter mode, standing on a platform supported by the chassis, because the ground clearance is then very limited. Thus, in rest position, the propulsion system is likely to jam or to stop regularly as soon as a small obstacle appears. Furthermore, this low ground clearance is likely to cause damage to the combined and simultaneous gripping and lifting means. This is the reason why a raising device can be provided. The raising device allows to raise (elevate) the gripping elements (tilt elements for example), without a wheel of the rolling object being gripped and lifted, so as to increase the ground clearance. A ground clearance of about 40 mm for example allows to keep a compact and easy-to-use system, and to limit jam risks and damage to the system. This raising device is also advantageous for use of the propulsion system in scooter mode in order to prevent the user from falling.

Preferably, the predetermined height can range between 30 mm and 50 mm, it is preferably close to 40 mm so as to provide sufficient ground clearance.

Advantageously, the raising device can comprise at least one return spring and/or at least one counterweight and/or at least one driven rod.

A return spring can allow to return a tilt element for example to a raised position as soon as the system is not coupled to a rolling object. Return to the raised position is then automatic.

A counterweight positioned on a tilt element for example on the side opposite the one close to the ground in rest position (without the counterweight) can allow to naturally bring the rest position to a position close to the raised position.

A rod driven by a cylinder, a linear actuator driven by a motor or any other drive system can also allow the gripping elements to be moved upwards so as to increase the ground clearance.

According to another variant, the extendable arm can be used to move the tilt element closer to the push device (or, conversely, to move the push device closer to the tilt element). Towards the end of the longitudinal displacement, the push device and the tilt element come into contact, which causes the tilt element to rise. An intermediate part positioned on the push device or the tilt element can facilitate contacting and rise of the tilt element.

Advantageously, a stop can be positioned on the frame or on the extendable arm to provide contact of the tilt element in raised position. The stop can be made of rubber or of an equivalent shock absorber material. The purpose of the stop is to keep the tilt element in raised position.

The invention also relates to a coupled assembly made up of a rolling object and an electric propulsion system as described above, the rolling object being coupled to the electric propulsion system by the coupling means. Such a coupled assembly facilitates the maneuvers of the rolling object, notably in a reduced space, as well as the coupling and uncoupling operations.

The coupled assembly as described is particularly suitable for rolling objects having at least one non-orientable wheel (preferably two non-orientable wheels), such as a wheelchair whose rear wheels are not orientable. Indeed, the propulsion system readily allows to grip and lift at least one non-orientable wheel of the rolling object by means of the push device opposite the tilt element and by means of the extendable arm on which the push device or the tilt element is mounted.

The invention further relates to a method for coupling a rolling object to the electric propulsion system described above. This method notably comprising the following steps:

a) moving the electric propulsion system so as to bring it close to at least one wheel of the rolling objet,

b) lengthening the extendable arm so as to enable positioning of the wheel of the rolling object between the tilt element and the push device. For example, if the tilt element and the push device are positioned substantially at the altitude of the axis of rotation of the wheel, the extendable arm can be extended in such a way that the space between the tilt element and the push device is greater than the diameter of the wheel to be gripped. When the tilt element and/or the push device are positioned at a lower altitude than the axis of rotation of the wheel (therefore closer to the ground), the distance between the tilt element and the push device can be less than the diameter of the wheel to be gripped, but it still needs to allow the wheel of the rolling object to be set between the tilt element and the push device,

c) moving the electric propulsion system in such a way that the wheel of the rolling object is positioned between the tilt element and the push device, ready to be gripped and lifted,

d) shortening the extendable arm in such a way that the push device or the tilt element contacts the wheel of the rolling object,

e) continuing shortening the extendable arm in such a way that the push device drives the wheel of the rolling object into the tilt element, which simultaneously causes the wheel of the rolling object to lift.

According to an advantageous implementation of the invention, two wheels of the rolling object can advantageously be gripped and lifted, for example two non-orientable wheels of the rolling object, such as the rear wheels of a wheelchair. The propulsion system therefore advantageously comprises two combined and simultaneous gripping and lifting means, mobile in transverse translation with respect to one another, each combined and simultaneous gripping and lifting means being dedicated to a distinct wheel of the rolling object. Thus, the method for coupling a rolling object to the electric propulsion system can comprise the following steps:

a) moving the electric propulsion system so as to bring it close to two wheels of the rolling objet,

b) moving transversely at least one of the two combined and simultaneous gripping and lifting means with respect to the other combined and simultaneous gripping and lifting means,

c) lengthening the extendable arm of each combined and simultaneous gripping and lifting means so that the spacing between the tilt element and the push device allows passage of a distinct wheel of the rolling object. For example, the space between the tilt element and the push device can be greater than the diameter of the rolling object wheel when the push device and the tilt element are positioned at the altitude of the axis of rotation of the rolling object wheel. If they are positioned at a lower altitude, closer to the ground, the space between the tilt element and the push device can be less than the diameter of the rolling object wheel between the tilt element and the push device. Step c) can be carried out before, after or simultaneously with step b),

d) moving transversely at least one of the two combined and simultaneous gripping and lifting means with respect to the other combined and simultaneous gripping and lifting means, in the opposite direction to step b), until each wheel of the rolling object is positioned between a push device and a tilt element,

e) shortening the extendable arms so as to drive each wheel of the rolling object into each tilt element by means of the push device, which simultaneously causes the wheel of the rolling object to lift.

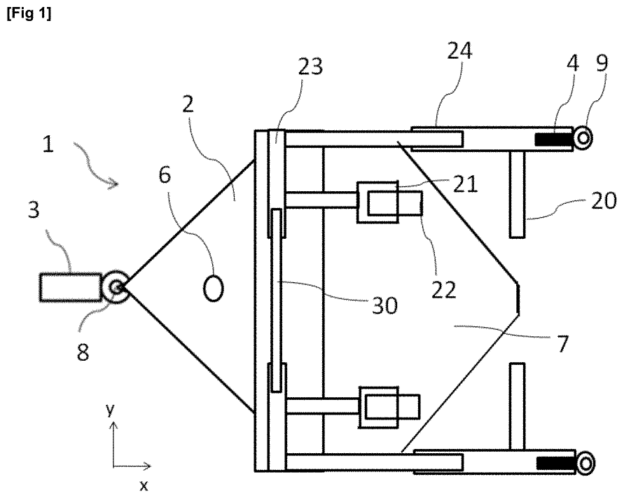

FIG. 1 schematically illustrates, by way of non-limitative example, an electric propulsion system 1 according to an embodiment of the invention. FIG. 1 is a top view of electric propulsion system 1. Electric propulsion system 1 comprises a chassis 2. Axis x corresponds to the longitudinal axis of chassis 2 and to the principal direction of displacement of propulsion system 1, and axis y corresponds to the lateral axis of chassis 2 (axis z, which is not shown, is vertical). Chassis 2 supports, at one of the longitudinal ends of electric propulsion system 1, a wheel 3 (alternatively, chassis 2 may support two wheels 3), which is a wheel driven by an electric machine (not shown). Wheel 3 is orientable with respect to chassis 2, about a vertical axis 8. At the other longitudinal end of electric propulsion system 1, the electric propulsion system comprises two wheels 4, which are wheels that are not driven by an electric machine. These two wheels 4 are off-centered wheels orientable about vertical axes 9. Electric propulsion system 1 further comprises coupling means.

According to the embodiment illustrated, the coupling means comprises two combined and simultaneous gripping and lifting means. Each combined and simultaneous gripping and lifting means comprises a frame 23 and a tilt element 22 such as a tilter, connected to frame 23 by a transverse-axis pivot connection 21. Each combined and simultaneous gripping and lifting means also comprises a push device 20 connected to an extendable arm 24 in the longitudinal direction. Extendable arm 24 therefore has a variable length in the longitudinal direction. One end of this extendable arm 24 is fastened to frame 23. Thus, extendable arm 24 allows to shorten or to lengthen the longitudinal distance between tilt element 22 and push device 20, so as to position a wheel of the rolling object between these two parts, then to drive the wheel into tilt element 22. Extendable arm 24 can notably comprise a cylinder for controlling lengthening or shortening of extendable arm 24. Non-driven wheels 4 are mounted by means of vertical axis 9, at the longitudinal end opposite the end connected to frame 23, of each extendable arm 24. Thus, the distance between non-driven wheels 4 and chassis 2 may vary. Positioning non-driven wheels 4 on extendable arm 24 allows to improve the load take-up once the rolling object coupled to electric propulsion system 1.

In order to ensure the distance and the proximity of frames 23 with respect to one another (and thus to ensure the transverse distance between the tilt elements and between the push devices), both frames 23 are connected by a sliding connection of transverse direction 30. This function can for example be fulfilled by a cylinder or a rack. The coupling means is arranged, in direction x, between motorized wheel 3 and orientable off-centered wheels 4.

Furthermore, electric propulsion system 1 comprises a handlebar 6, for example in form of a rod equipped with a handle (not shown).

Besides, electric propulsion system 1 can comprise a supporting platform 7 (for supporting a user for example).

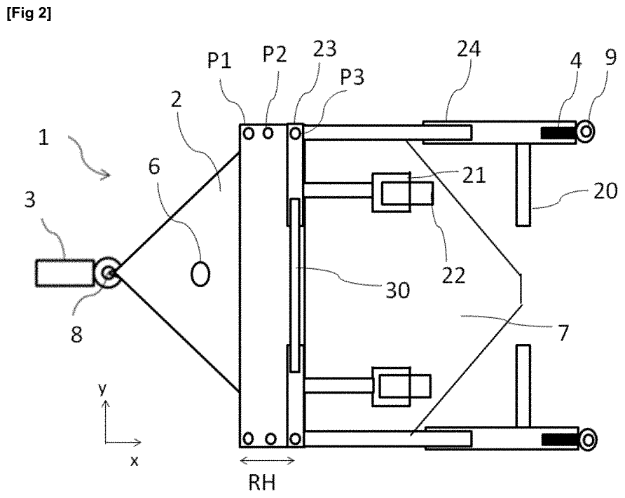

FIG. 2 schematically illustrates, by way of non-limitative example, a variant of FIG. 1. Identical references correspond to the same elements and to the same operations, and they are therefore not detailed here. FIG. 2 differs from FIG. 1 in that frames 23 are longitudinally adjustable on the chassis. In other words, the longitudinal position of frames 23 along chassis 2 can be modified. Frames 23 can be moved in the direction RH. As schematically shown in the figure, three longitudinal positions P1, P2 and P3 are represented for each frame 23 on chassis 2. These three positions P1, P2, P3 are represented by orifices in which a pin can be set so as to lock frame 23 in the desired longitudinal position. Alternatively, the longitudinal adjustment could be provided in a more precise manner by an actuator such as a cylinder.

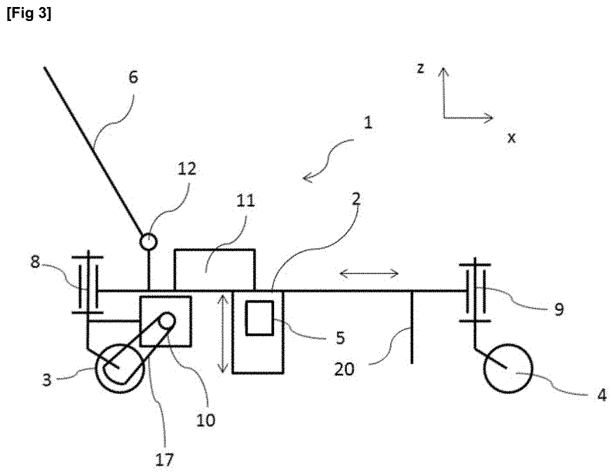

FIG. 3 schematically illustrates, by way of non-limitative example, an electric propulsion system 1 according to a first variant embodiment of the invention. FIG. 3 is a side view of electric propulsion system 1. Electric propulsion system 1 comprises a chassis 2. Axis x corresponds to the longitudinal axis of chassis 2 and to the principal direction of displacement of the propulsion system, and axis z corresponds to the vertical axis of chassis 2, axis y (not shown) corresponding to the transverse axis. Chassis 2 supports a wheel 3, which is a wheel driven by an electric machine 10 by means of a drive 17, a belt or a chain for example (alternatively, electric machine 10 may be directly connected to wheel 3). Wheel 3 is orientable with respect to chassis 2, around a vertical axis 8. Electric machine 10 can be integral with vertical-axis pivot 8 of motorized wheel 3. At the other end of the propulsion system, two extendable arms represented by a horizontal double arrow support each a wheel 4 that is not driven by an electric machine. Wheels 4 are off-centered and orientable with respect to the extendable arms around vertical axes 9. The extendable arms can be lengthened or shortened along longitudinal direction x.

Electric propulsion system 1 further comprises a coupling means 5. The vertical movement of coupling means 5 is shown by a vertical double arrow. This vertical movement of the coupling means allows combined and simultaneous gripping and lifting of the wheels of the rolling object, this vertical movement being simultaneous and combined with the transverse movement of coupling means 5 so as to simultaneously generate gripping and lifting of the wheels of the rolling object. Coupling means 5 are arranged, in direction x, between motorized wheel 3 and orientable off-centered wheels 4.

The coupling means comprises a push device 20 positioned and fastened on the extendable arm.

Furthermore, electric propulsion system 1 comprises a handlebar 6, for example in form of a rod equipped with a handle (not shown) connected to chassis 2 by means of a joint 12.

Besides, electric propulsion system 1 comprises a battery 11. Battery 11 is arranged on chassis 2 close to electric machine 10 and to motorized wheel 3.

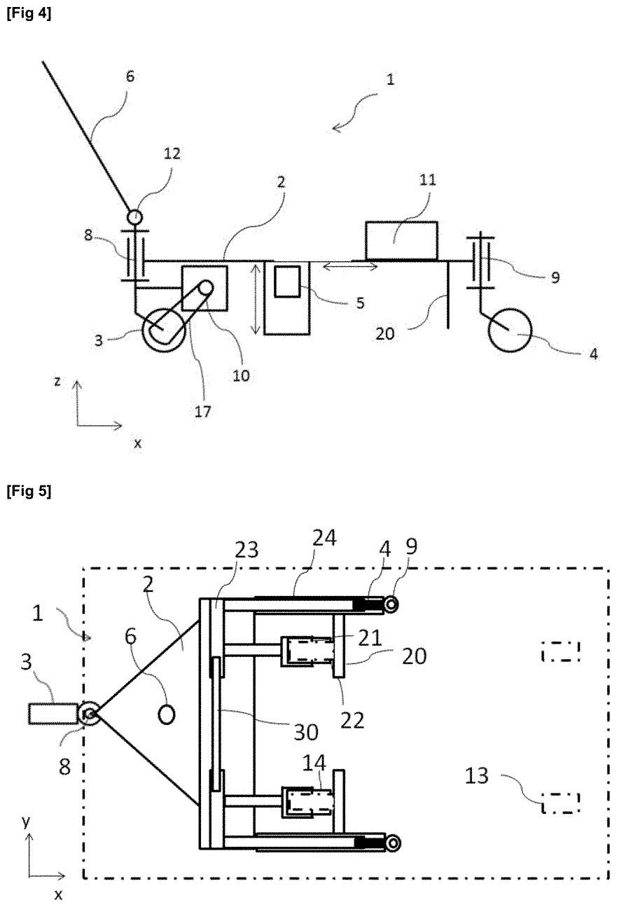

FIG. 4 schematically illustrates, by way of non-limitative example, an electric propulsion system 1 according to a second variant embodiment of the invention. FIG. 4 is a side view of electric propulsion system 1. Electric propulsion system 1 comprises a chassis 2. Axis x corresponds to the longitudinal axis of chassis 2 and to the principal direction of displacement of the propulsion system, and axis z corresponds to the vertical axis of chassis 2. Chassis 2 supports a wheel 3, which is a wheel driven by an electric machine 10 by means of a drive 17, a belt or a chain for example. Wheel 3 is orientable with respect to chassis 2, around a vertical axis 8. Electric machine 10 can be integral with vertical-axis pivot 8 of motorized wheel 3. At the other end of electric propulsion system 1, two arms extendable in the longitudinal direction, represented by a horizontal double arrow, support each a wheel 4. Wheels 4 are not driven by an electric machine. Wheels 4 are off-centered and orientable with respect to the extendable arms around vertical axes 9.

Electric propulsion system 1 further comprises a coupling means 5. Coupling means 5 comprises two combined and simultaneous gripping and lifting means on either side of chassis 2. The vertical movement of the combined and simultaneous gripping and lifting means is shown by a vertical double arrow. This vertical movement of the combined and simultaneous gripping and lifting means allows combined and simultaneous gripping and lifting of the wheels of the rolling object. This vertical movement is driven by the transverse movement of the combined and simultaneous gripping and lifting means. Coupling means 5 is arranged, in direction x, between motorized wheel 3 and orientable off-centered wheels 4.

Each combined and simultaneous gripping and lifting means comprises a push device 20 positioned and fastened on the extendable arm.

Furthermore, propulsion system 1 comprises a handlebar 6, for example in form of a rod equipped with a handle (not shown) connected to vertical orientation axis 8 of motorized wheel 3 by means of a joint 12.

Besides, electric propulsion system 1 comprises a battery 11. Battery 11 is arranged close to non-motorized wheels 4.

FIG. 5 schematically illustrates, by way of non-limitative example, an electric propulsion system 1 according to an embodiment of the invention coupled to a rolling object represented by the rectangle in dash-dot line. FIG. 5 is a top view of electric propulsion system 1 coupled to the rolling object. The embodiment of FIG. 5 substantially corresponds to the embodiment of FIG. 1 (platform 7 of FIG. 1 is not shown for diagram readability reasons). References identical to those of FIG. 1 correspond to the same elements and are therefore not detailed here. The rolling object can be of any type, notably a wheelchair, electric propulsion system 1 being particularly suited for gripping and lifting non-orientable wheels. The rolling object comprises two wheels 14, referred to as rear wheels, which can advantageously be non-orientable wheels, and two wheels 13, arbitrarily referred to as front wheels. Electric propulsion system 1 comprises a chassis 2. Axis x corresponds to the longitudinal axis of chassis 2 and to the principal direction of displacement of propulsion system 1, and axis y corresponds to the lateral axis of chassis 2. Chassis 2 supports a wheel 3, which is a wheel driven by an electric machine (not shown). Wheel 3 is orientable with respect to chassis 2, around a vertical axis 8. The other end of electric propulsion system 1 is provided with two extendable arms 24 carrying two wheels 4 that are not driven by an electric machine, these wheels 4 being off-centered and orientable around vertical axes 9. Electric propulsion system 1 further comprises a coupling means provided with two combined and simultaneous gripping and lifting means, each being close to a transverse end of electric propulsion system 1. The combined and simultaneous gripping and lifting means comprise each a frame 23 connected to chassis 2 by a transverse-axis sliding connection 30. In FIG. 5, transverse sliding connection 30 is common to the two frames 23. On each frame 23, a tilt element 22 is mounted on a transverse-axis pivot connection 21. Moreover, a push device 20 is fastened to each extendable arm 24. The longitudinal movement of each extendable arm 24 thus drives push device 20 towards tilt element 22 (movement of extendable arm 24 in direction −x) or, conversely, in the opposite direction (movement of extendable arm 24 in direction x).

As shown in FIG. 5, rear wheels 14 have been driven by push devices 20 towards tilt elements 22, thus causing wheels 14 of the rolling object to be gripped and lifted.

Electric propulsion system 1 also comprises a handlebar 6, for example in form of a rod equipped with a handle (not shown) articulated with respect to chassis 2.

For the embodiment of FIG. 5, the coupling means, non-motorized wheels 4 and a major part of electric propulsion system 1 are arranged under the rolling object. Only motorized wheel 3 and handlebar 6 can protrude from rolling object 13 in the longitudinal direction x of chassis 2.

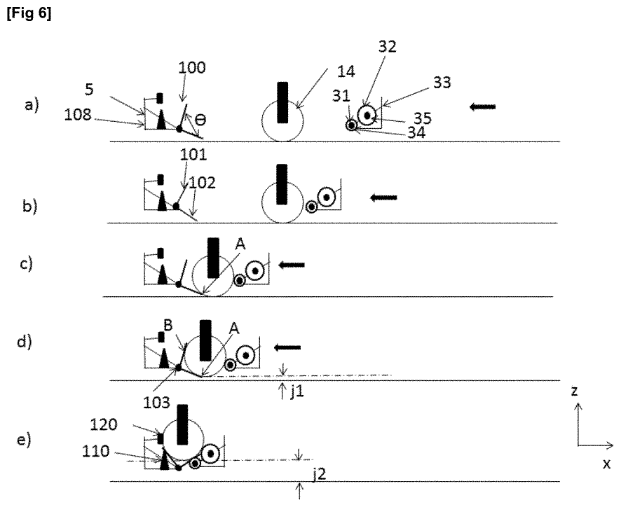

FIG. 6 schematically illustrates, by way of non-limitative example, a first embodiment of the combined and simultaneous gripping and lifting means of a propulsion system according to the invention.

This propulsion system comprises a coupling means 5 with a combined and simultaneous gripping and lifting means. This combined and simultaneous gripping and lifting means comprises gripping elements including a frame 108, which is a structure that cannot move vertically. A tilt element (a tilter for example) 100 is fastened to this frame 108. This tilt element 100 is connected to frame 108 by a transverse-axis pivot connection 103, orthogonal to the cutting plane, direction x representing the longitudinal direction and direction z representing the vertical direction. Tilt element 100 comprises two parts 101 and 102 rigidly fixed to each other and forming a non-zero angle θ, thus forming a bent piece. Tilting of tilt element 100 occurs through the gravity of the tilt element alone or of the tilt element supporting a rolling object. In other words, tilting of tilt element 100 is not controlled by a control means (a cylinder for example). Pivot connection 103 is advantageously positioned at the link between the two parts 101 and 102 forming open angle θ.

A push device connected to an extendable arm (not shown) in longitudinal direction x is arranged opposite tilt element 100. This push device comprises a support 33 connected to the extendable arm. For example, it can be fastened to the extendable arm. This support 33 supports two rollers 31 and 32 that can respectively pivot about their transverse axes 34 and 35, and are connected to support 33. The diameter of first roller 31 is smaller than the diameter of second roller 32 and the altitude of transverse axis 34 of first roller 31 is lower than the altitude of transverse axis 35 of second roller 32. Thus, first roller 31 is designed to provide the first contact between the push device and wheel 14 of the rolling object. Once wheel 14 has started lifting in tilt element 100, wheel 14 comes into contact with second roller 32. Since this second roller has a larger diameter and a higher altitude, it allows to improve the holding in position of wheel 14 of the rolling object in tilt element 100 during operation. In other words, second roller 32 is a better obstacle than first roller 31 for holding the rolling object in the electric propulsion system.

FIG. 6 illustrates with five diagrams a), b), c), d) and e) the different steps relative to the approach, gripping and lifting of at least one wheel of the rolling object.

In step a), wheel 14 of the rolling object is neither in contact with tilt element 100, nor with the push device of the combined and simultaneous gripping and lifting means. It is notably at a distance from part 102 of tilt element 100 and from first roller 31 of the push device. Part 102 is at a short distance from the ground to facilitate gripping and lifting of the wheels.

The black arrows represent the movement applied to the push device by means of the extendable arm, not shown, in the direction of the tilt element.

In step b), the push device comes into contact with wheel 14 of the rolling object.

Indeed, first roller 31 is in contact with wheel 14.

As the longitudinal displacement of the push device towards tilt element 100 continues, the push device (first roller 31) drives wheel 14 of the rolling object towards the tilt element.

In step c), wheel 14 of the rolling object, driven by the push device, comes into contact at point A with tilt element 100. Once contact is achieved at point A between tilt element 100 and wheel 14 of the rolling object, tilt element 100 tilts until a second contact is achieved between wheel 14 of the rolling object and tilt element 100 at point B, as shown in diagram d). The assembly made up of tilt element 100 and wheel 14 of the rolling object can then tilt, which simultaneously allows to grip and to lift wheel 14 of the rolling object. The continuation of the longitudinal movement of the extendable arm causes tilt element 100 and wheel 14 of the rolling object to tilt. A clearance j1 that can be seen in diagram d) then appears between the lower part of wheels 14 of the rolling object and the ground, represented in the various diagrams by a solid horizontal line. It is also noted that tilt element 100 has slightly rotated around its pivot connection 103, the wheel being in contact with wheel support part 102 at contact point A and with the other part 101 of tilt element 100 at contact point B.

As the longitudinal displacement of the push device continues, tilt element 100 is rotated about its pivot connection 103 as a result of each wheel 14 of the rolling object bearing against tilt element 100. The combined and simultaneous gripping and lifting means continue to grip and lift wheels 14 of the rolling object until the final position shown in diagram e) is reached, where clearance j2 between the lower part of each wheel 14 of the rolling object and the ground is maximal, with j2 greater than j1. In this final position, each wheel 14 of the rolling object is immobilized in coupling means 5 and rests, in the longitudinal direction, on first stops 120 positioned on frame 108. Furthermore, a holding part 110 allows tilt element 100 to be held in this position, referred to as raised position, against frame 108. This holding part 110, also positioned on frame 108, is arranged under tilt element 100 in raised position. Holding part 110 allows to take up the forces related to the weight of the rolling object on the combined and simultaneous gripping and lifting means, thereby allowing to limit the fatigue of tilt elements 100.

Holding part 110 and/or first stops 120 are preferably made of a flexible material such as rubber so as to avoid static redundancy on the one hand and to adapt to different wheel diameters on the other hand.

It can also be noted that, in diagram e), in the final position, wheel 14 of the rolling object is in contact with second roller 32 and that first roller 31 would not allow wheel 14 to be held in the tilt element due to its too small diameter and to too low a position in relation to the final position of wheel 14 of the rolling object.

Thus, by imposing a single longitudinal translational movement (black arrow), gripping and lifting of wheel 14 of the rolling object is carried out in a combined and simultaneous manner.

FIG. 6 illustrates a method and a system wherein the push device is translatably driven by the extendable arm, but it is clear that the system could be reversed, in which case the tilt element can be driven by the extendable arm and the push device is then stationary on the frame.

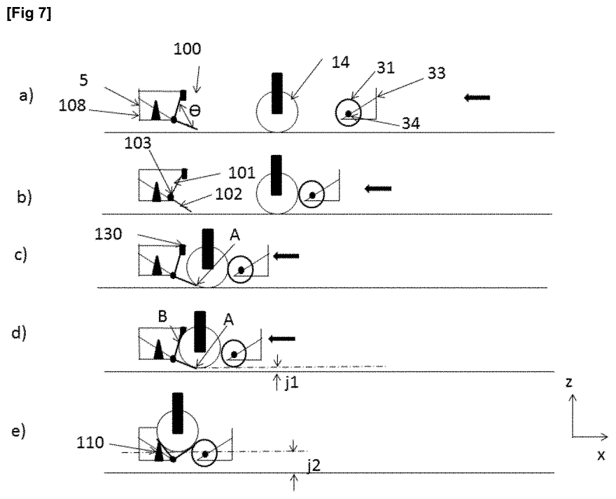

FIG. 7 schematically illustrates, by way of non-limitative example, another embodiment of a combined and simultaneous gripping and lifting means of a propulsion system according to the invention.

In this figure, the propulsion system comprises a coupling means 5 with a combined and simultaneous gripping and lifting means. This combined and simultaneous gripping and lifting means comprises gripping elements including a frame 108, which is a structure that cannot move vertically. A tilt element 100 is fastened to frame 108 by a transverse-axis pivot connection 103, orthogonal to the cutting plane, direction x representing the longitudinal direction and direction z representing the vertical direction. Tilt element 100, a tilter for example, comprises two parts 101 and 102 rigidly fixed to each other and forming a non-zero open angle θ, thus forming a bent piece. Pivot connection 103 is advantageously positioned at the link between the two parts 101 and 102.

An angular clearance limiting device 130 is used to limit the angular clearance of tilt element 100. It thus allows to predefine the distance between the bottom of the tilt element and the ground in rest position.

Furthermore, the combined and simultaneous gripping and lifting means comprises a push device fastened to an extendable arm (not shown) in longitudinal direction x. The push device notably comprises a support 33 connected to the extendable arm so that the longitudinal displacement of the extendable arm is transmitted to support 33. A roller 31 is mounted on a transverse-axis pivot connection 34, itself mounted on support 33.

FIG. 7 illustrates with five diagrams a), b), c), d) and e) the different steps relative to the approach, gripping and lifting of at least one wheel of the rolling object.

In step a), wheel 14 of the rolling object is neither in contact with tilt element 100, nor with roller 31 of the push device of the combined and simultaneous gripping and lifting means. It is notably at a distance from part 102 of tilt element 100 and from roller 31. Moreover, part 102 is at a short distance from the ground to facilitate gripping and lifting of the wheel of the rolling object.

The black arrows represent the longitudinal movement applied to the push device by means of the extendable arm in the direction of the tilt element (in direction −x).

In step b), roller 31 of the push device comes into contact with wheel 14 of the rolling object.

As the longitudinal displacement of the extendable arm continues, the push device then drives wheel 14 of the rolling object towards the tilt element.

In step c), wheel 14 of the rolling object comes into contact at point A with tilt element 100. The longitudinal movement of the extendable arm then causes the wheel to tilt around point A until it comes into contact with point B of part 101 of tilt element 100. A clearance j1 that can be seen in diagram c) then appears between the lower part of wheels 14 of the rolling object and the ground, represented in the various diagrams by a solid horizontal line. It is also noted that each first tilt element 100 may have slightly rotated around its pivot connection 103, the wheel being in contact with wheel support part 102 at contact point A and with the other part 101 of each first tilt element 100 at contact point B. In other words, part 101 of the tilt element is no longer in contact with angular clearance limiting device 130.

The combined and simultaneous gripping and lifting means then continues to grip and lift wheels 14 of the rolling object until the final position shown in diagram e) is reached, where clearance j2 between the lower part of each wheel 14 of the rolling object and the ground is maximal, with j2 greater than j1. In this final position, each wheel 14 of the rolling object is immobilized in coupling means 5 and rests, in the longitudinal direction, against first roller 31.

Thus, by imposing a single longitudinal translational movement (black arrow), gripping and lifting of wheel 14 of the rolling object is carried out in a combined and simultaneous manner.

FIG. 7 illustrates a method and a system wherein the push device is translatably driven by the extendable arm, but it is clear that the system could be reversed, in which case the tilt element can be driven by the extendable arm and the push device is then stationary on the frame.

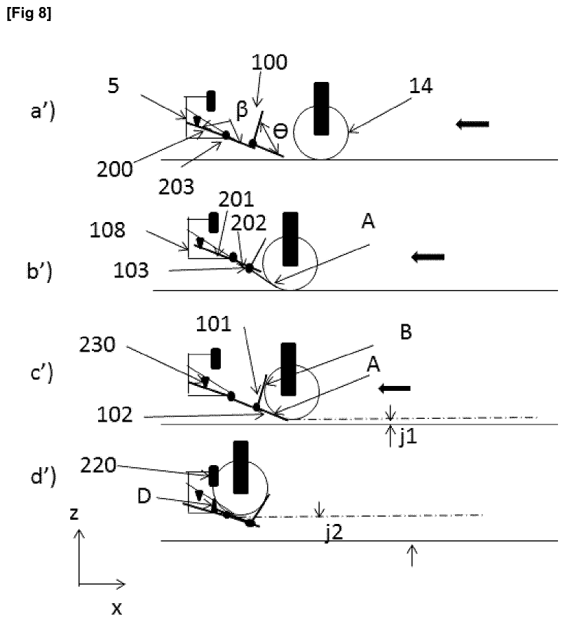

FIG. 8 schematically illustrates, by way of non-limitative example, another embodiment of a combined and simultaneous gripping and lifting means of a propulsion system according to the invention.

This propulsion system comprises a coupling means 5 with a combined and simultaneous gripping and lifting means. This combined and simultaneous gripping and lifting means comprises gripping elements including a frame 108, which is a structure that cannot move vertically. A second tilt element 200 (a tilter for example) is fastened to this frame 108. This second tilt element 200 is connected to frame 108 by a transverse-axis pivot connection 203, orthogonal to the cutting plane, direction x representing the longitudinal direction and direction z representing the vertical direction. Tilt element 200 comprises two parts 201 and 202 rigidly fixed to each other and forming a non-zero open angle. Pivot connection 203 is advantageously positioned at the link between the two parts 201 and 202.

This second tilt element 200 is itself connected to a first tilt element 100 by a substantially horizontal axis 103 forming a pivot connection between the first and the second tilt element 100 and 200. Substantially horizontal axis 103 is oriented along the transverse direction (orthogonal to the cutting plane). This horizontal axis is thus parallel to pivot connection 203. Horizontal axis 103 is advantageously positioned at the link between the two rigidly connected parts 101 and 102 forming a non-zero open angle, the two parts 101 and 102 making up tilt element 100, a tilter for example. The multiplicity of tilt elements allows to reduce the force required to initiate gripping and lifting of wheels 14 of the rolling object.

The push device is not shown in FIG. 8. It may correspond to the push device of FIG. 6 or FIG. 7 for example. Only the black arrows show the longitudinal displacement of the push device driving wheel 14 of the rolling object towards tilt element 100.

FIG. 8 illustrates with four diagrams a′), b′), c′) and d′) the different steps relative to the approach, gripping and lifting of at least one wheel of the rolling object.

In step a′), wheel 14 of the rolling object is not in contact with tilt element 100 yet. It is notably at a distance from part 102 of first tilt element 100, this part 102 being at a short distance from the ground to facilitate gripping and lifting of the wheels.

The black arrows represent the displacement applied to the push device.

In step b′), wheel 14 of the rolling object comes into contact at point A with the tilt element. Tilt element 100 can then pivot until a second contact is achieved at point B between tilt element 100 and wheel 14 of the rolling object.

After achieving contact at points A and B, the longitudinal displacement of the push device towards tilt element 100 causes the assembly made up of wheel 14 of the rolling object and tilt element 100 to tilt, thereby causing wheel 14 of the rolling object to be gripped and lifted as shown in diagram c′). A clearance j1 appears between the lower part of wheels 14 of the rolling object and the ground, represented in the various diagrams by a solid horizontal line.

As the longitudinal displacement of the push device continues, first tilt element 100 is driven in rotation around its pivot connection 103 as each wheel 14 of the rolling object rests upon each first tilt element 100, each first tilt element 100 driving second tilt element 200 in rotation around its pivot connection 203. Stops, not shown, can be provided between the wheel and tilt element 200 or between tilt element 100 and tilt element 200 to allow tilt element 200 to be driven in rotation. The combined and simultaneous gripping and lifting means then continues to grip and lift wheels 14 of the rolling object until the final position shown in diagram d′) is reached, where clearance j2 between the lower part of each wheel 14 of the rolling object and the ground is maximal, with j2 greater than j1. In this final position, each wheel 14 of the rolling object is immobilized in coupling means 5 and rests, in the longitudinal direction, on the push device (a roller for example).

Furthermore, a second angular clearance limiting device 230 positioned on frame 108 prevents angular displacement of part 201 of second tilt element 200 beyond this angular clearance limiting device 230. In diagrams a′), b′) and c′), part 201 of second tilt element 200 is in contact with angular clearance limiting device 230 that thus fulfils its purpose by limiting the rotation of second tilt element 200 about its pivot connection 203. In diagram d′), part 201 of second tilt element 200 is no longer in contact with angular clearance limiting device 230.

Such a configuration allows to limit the force variations for gripping and lifting the wheel of the rolling object immediately after contacting point A and until the wheel comes into contact with point B.

Thus, by imposing a single longitudinal translational movement (black arrow), gripping and lifting of the wheel of the rolling object is carried out in a combined and simultaneous manner.

FIG. 8 illustrates a method and a system wherein the push device is translatably driven by the extendable arm, but it is clear that the system could be reversed, in which case the tilt element can be driven by the extendable arm and the push device is then stationary on the frame.

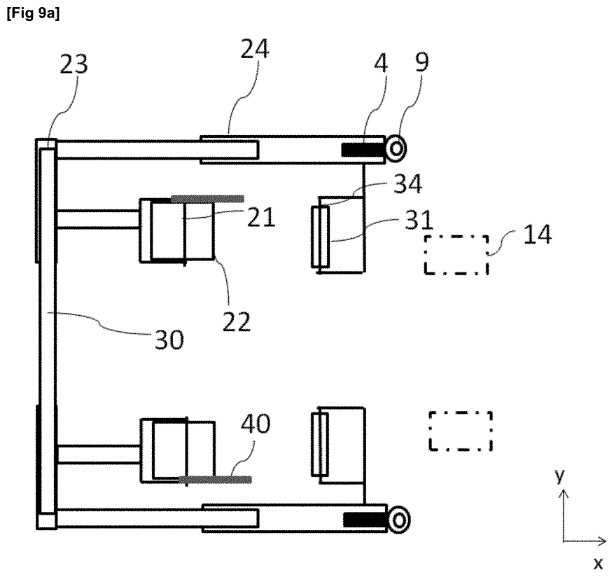

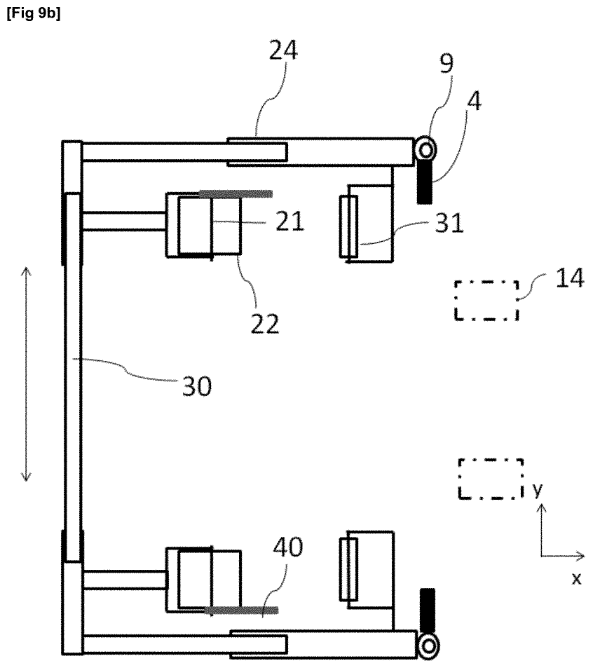

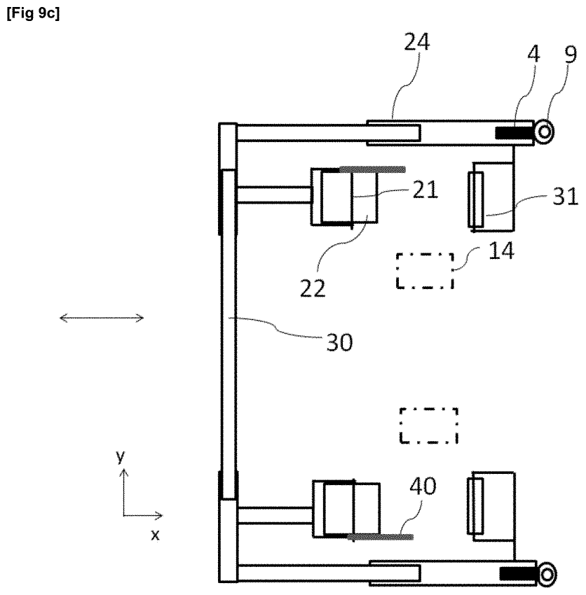

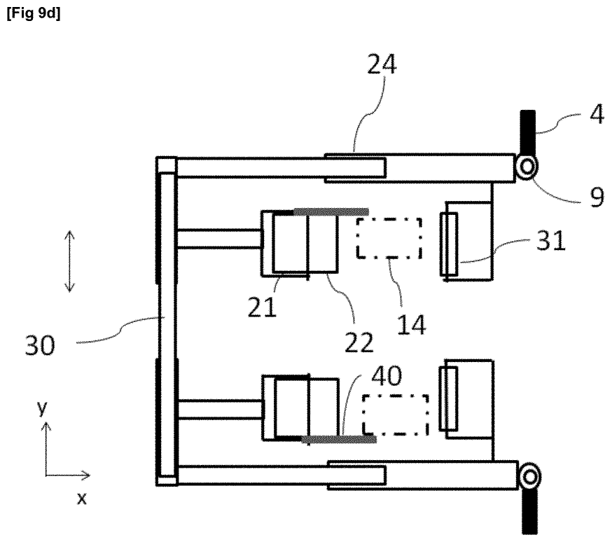

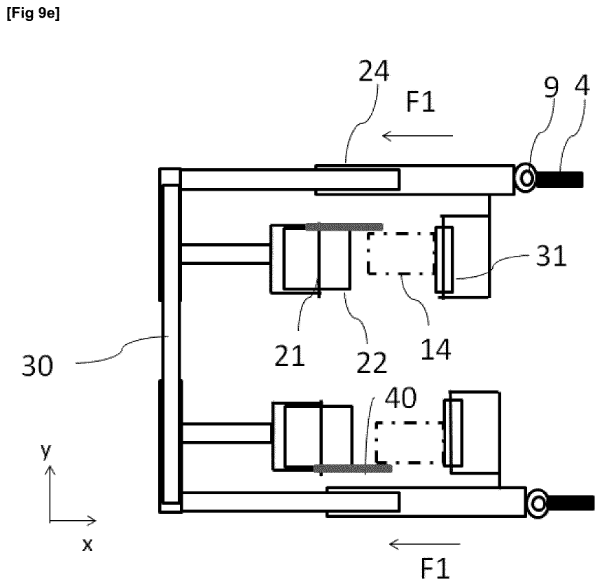

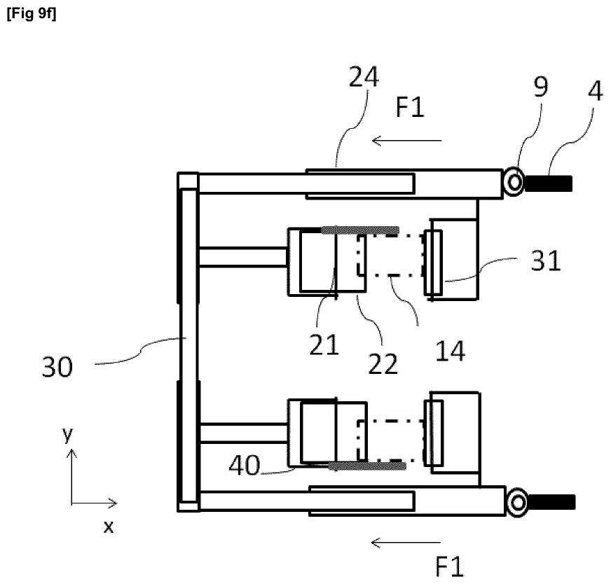

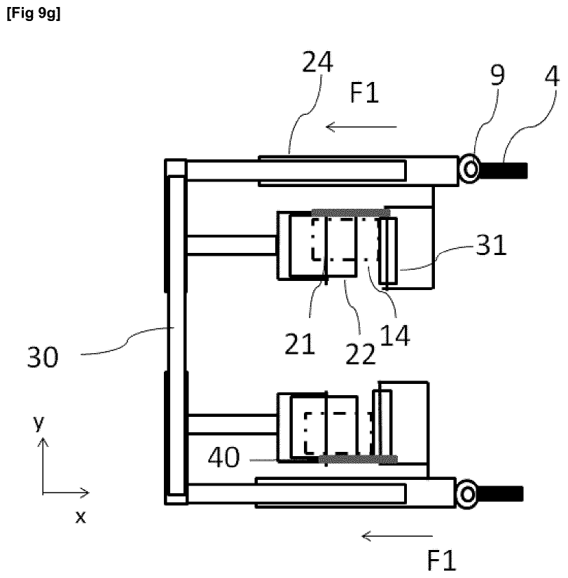

FIGS. 9a to 9g schematically illustrate, by way of non-limitative example, the different steps for gripping and lifting two wheels of a rolling object from a variant of an electric propulsion system of the invention comprising two combined and simultaneous gripping and lifting means. Axis x corresponds to the longitudinal axis and axis y corresponds to the transverse axis.

This propulsion system comprises a coupling means with two combined and simultaneous gripping and lifting means. Each combined and simultaneous gripping and lifting means comprises a frame 23 and a tilt element 22 connected to frame 23 by a transverse-axis pivot connection 21. A push device is fastened to an extendable arm 24 connected to frame 23. Therefore, the distance between the push device and frame 23 can be modified by lengthening or shortening extendable arm 24. An off-centered non-driven wheel 4 orientable about a vertical axis 9 is positioned at the longitudinal end of the extendable arm opposite the longitudinal end of the extendable arm fastened to frame 23.

The two frames 23 are in transverse-axis sliding connection 30 so as to move the two combined and simultaneous gripping and lifting means transversely away from each other. In other words, the transverse distance between the two combined and simultaneous gripping and lifting means can be varied by sliding one and/or other of the combined and simultaneous gripping and lifting means along transverse-axis slide 30. This (or these) translation(s) can for example be actuated by a hydraulic, electric or pneumatic cylinder.

The push device notably comprises a support fastened to the extendable arm. A roller 31 is connected to the support by a transverse-axis pivot connection 34.

Besides, an approach stop 40 is fastened to frame 23, close to a transverse end of tilt element 22 of each combined and simultaneous gripping and lifting means. Alternatively, the approach stop could be fastened to the transverse end of the tilt element.

Approach stop 40 substantially extends in the longitudinal direction, in the direction of the push device opposite tilt element 22, and it is positioned on the outer side of the electric propulsion system. Therefore, when the combined and simultaneous gripping and lifting means moves in the transverse direction, wheel 14 of the rolling object comes into contact with approach stop 40. Once contact achieved, the transverse displacement of the combined and simultaneous gripping and lifting means can be stopped.

FIG. 9a shows an example of a situation where the initial position of the combined and simultaneous gripping and lifting means does not allow wheels 14 of the rolling object to be positioned between tilt elements 22 and roller 31 of the push device.

FIG. 9b shows a first step where the two combined and simultaneous gripping and lifting means are moved away from one another by means of slide 30. This distancing is represented by the transverse double arrow in the diagram. As shown, moving the two combined and simultaneous gripping and lifting means away from one another allows the electric propulsion system to be driven forward in the direction of the rolling object so that the combined and simultaneous gripping and lifting means are each positioned on a lateral outer side of the rolling object.

The transverse displacement by extension of slide 30 drives wheels 4 of the electric propulsion system towards the inside of the electric propulsion system. Indeed, wheels 4 being self-orienting, the transverse displacement of slide 30 drives wheels 4 in the transverse direction and in the opposite direction to the displacement of slide 30.

FIG. 9c shows the relative positioning of wheels 14 of the rolling object and of the combined and simultaneous gripping and lifting means once the electric propulsion system moved forward in the longitudinal direction as shown by the horizontal double arrow.

In FIG. 9d, the two combined and simultaneous gripping and lifting means are moved closer to each other by transverse-axis slide 30, until each one of wheels 14 comes into contact with an approach stop 40. Once contact achieved, the transverse translation of the combined and simultaneous gripping and lifting means is stopped.

The transverse displacement by decreasing the length of slide 30 drives wheels 4 of the electric propulsion system towards the outside of the electric propulsion system. Indeed, wheels 4 being self-orienting, the transverse displacement of slide 30 drives wheels 4 in the transverse direction and in the opposite direction to the displacement of slide 30.

In FIG. 9e, extendable arm 24 gets shorter. Indeed, extendable arm 24 performs a longitudinal translation F1 in the direction of frame 23. Therefore, the displacement of the extendable arm drives the push device and notably roller 31.

This longitudinal displacement F1 provides contact between each wheel 14 and a roller 31 of the push device. Once contact achieved, the continuation of longitudinal displacement F1 drives wheels 14 of the rolling object towards tilt elements 22. This displacement also drives wheels 4 of the electric propulsion system in the longitudinal direction.

In FIG. 9f, it can be seen that each wheel 14 comes into contact with tilt element 22.

As the longitudinal displacement F1 of extendable arm 24 continues, wheels 14 reach their final positions in the tilt element while remaining in contact with roller 31 of the push device. These final positions are shown in FIG. 9g. Coupling of the rolling object to the electric propulsion system is then finalized. The rolling object can then be readily transported by means of the electric propulsion system.

Reducing the length of extendable arm 24 causes orientation of wheels 4 of the electric propulsion system in the longitudinal direction opposite to extendable arm 24, i.e. in the opposite direction to the displacement of extendable arm 24.

FIG. 10 schematically shows, by way of non-limitative example, a variant of the system illustrated in FIGS. 9a to 9g. In this variant, the push device comprises two guide pieces 51a and 51b positioned on either side of roller 31. According to a variant, these two guide pieces 51a and 51b could be positioned on either side of the tilt element. Axis x corresponds to the longitudinal axis and axis y corresponds to the transverse axis.

These two guide pieces 51a and 51b extend substantially in the longitudinal direction, in the direction of frame 23. These two guide pieces 51a and 51b prevent orientable wheels 14 of the rolling object from pivoting during the longitudinal displacement of the extendable arm towards the tilt elements. In other words, these two guide pieces 51a and 51b maintain wheel 14 substantially in the longitudinal direction.

Besides, at least one of the two guide pieces 51a and 51b can be movable along the transverse direction Reg so as to be able to adapt the space between the two guide pieces to the width of wheel 14 of the rolling object.

Thus, the orientation of wheels 14, when they are orientable, can be maintained with good precision in the longitudinal direction.

Besides, the push device comprises, compared with the system of FIGS. 9a to 9g, a second roller 32 connected to the support by a transverse-axis pivot connection 35. The two transverse axes 34 and 35 are thus parallel to each other. Transverse axis 35 of second roller 32 is at an altitude above ground greater than the altitude above ground of transverse axis 34 of first roller 31. Moreover, the diameter of second roller 32 can be greater than the diameter of first roller 31. This double roller configuration provides greater adaptability of the system to different diameters of wheels 14 of the rolling object, second roller 32 notably providing a better obstacle for keeping the coupled assembly in operation, first roller 31 serving to initially push the wheel and to facilitate contact and lift start of wheel 14 of the rolling object in tilt element 22.

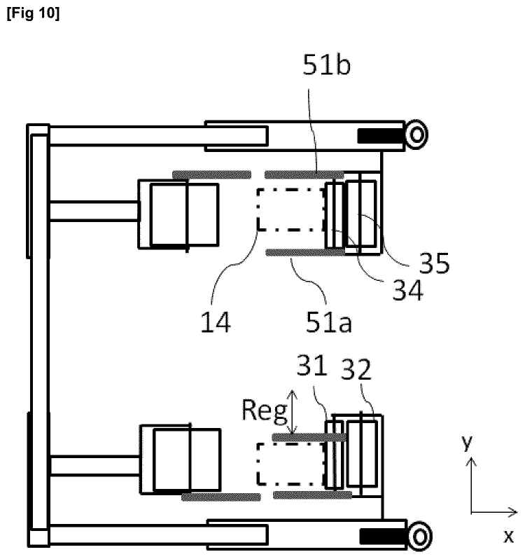

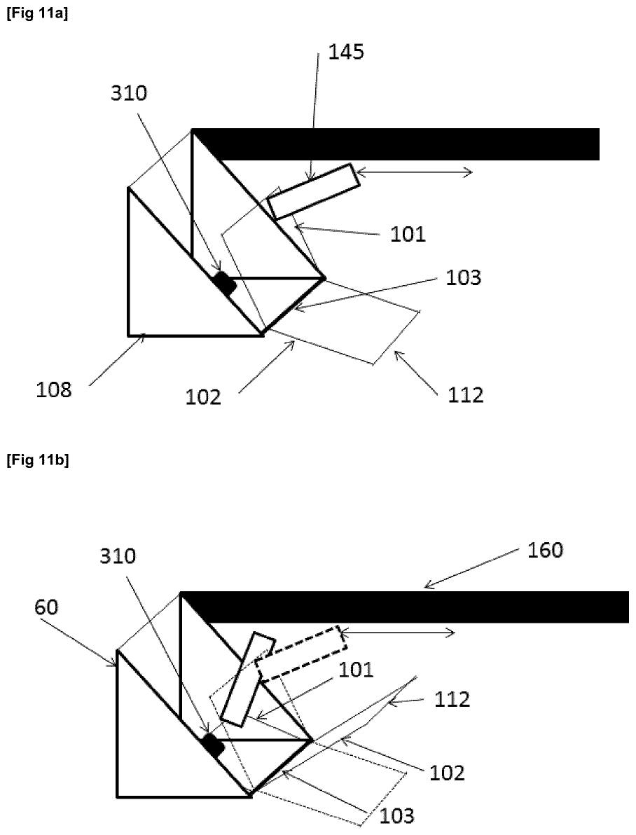

FIGS. 11a and 11b schematically illustrate, by way of non-limitative example, an embodiment of a device for raising a combined and simultaneous gripping and lifting means according to the invention.

In these figures, the combined and simultaneous gripping and lifting means comprises a frame 108. A tilt element made up of two parts 101 and 102, rigidly fastened to each other and forming a non-zero open angle, is positioned on this frame 108. The tilt element pivots about a horizontal-axis pivot connection 103 connected to frame 108, enabling rotation of the tilt element with respect to frame 108. The tilt element allows to simultaneously achieve gripping and lifting of the rolling object wheel. Pivot connection 103 is advantageously positioned at the link between the two parts 101 and 102.

Furthermore, a holding part 310 allows to hold up the tilt element when it supports the wheel of the rolling object so as to improve the taking up of forces and to limit fatigue of the tilt element. According to a variant, holding part 310 can support the wheel of the rolling object.

Furthermore, a cam 145 is rigidly fastened on the tilt element. At the end of cam 145 that is not fastened to the tilt element, a displacement in the longitudinal direction can be applied by a rod or a cylinder for example. This displacement is represented by the double arrow. When cam 145 is moved in the direction of frame 108, cam 145 causes the tilt element to be raised. The ground clearance is then increased. On the other hand, displacement of cam 145 in the opposite direction to frame 108 causes the tilt element to lower very close to the ground, thus facilitating gripping and lifting of the rolling object wheels. Displacement of cam 145 can be advantageously linked with an actuator that simultaneously allows to raise the tilt elements of two opposite combined and simultaneous gripping and lifting means.

Cam 145 can be driven for example by the push device, itself driven by the extendable arm.

Alternatively or in combination, a counterweight system could be used for raising the tilt elements.

FIG. 11a shows the tilt element in rest position, ready to grip and lift a wheel of the rolling object.

In FIG. 11b, the rest position is shown in dotted line and the raised position of the tilt element is shown in solid line. It can thus be noted that part 112 supporting the wheel, which is initially the lowest point, is raised and is therefore, in raised position, at a higher altitude than in the rest position.

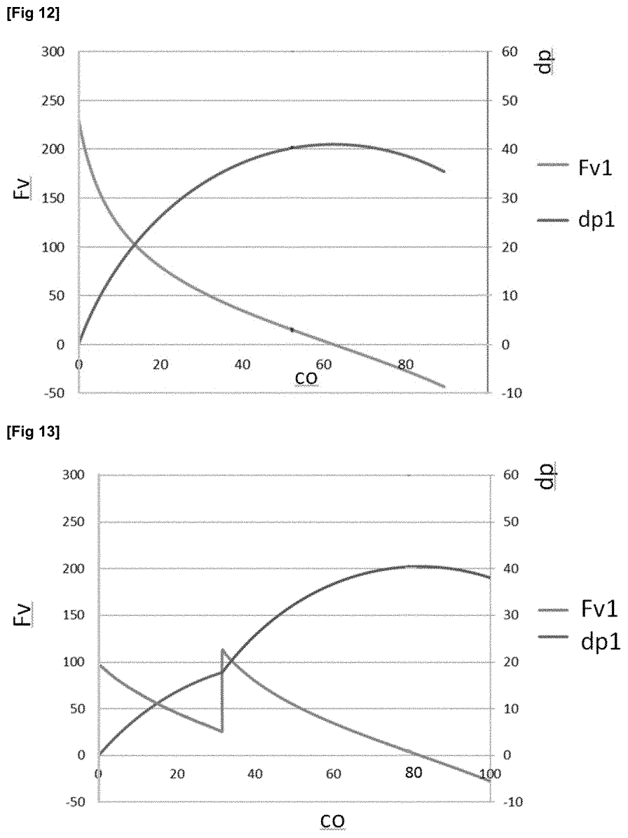

FIGS. 12 and 13 show the evolution of the force Fv applied by the cylinder(s) during the travel co (in the transverse direction) applied to the combined and simultaneous gripping and lifting means, the initial point of travel co corresponding to the first contact between the rolling object wheel and the first tilt element. Travel co occurs in the longitudinal direction of the propulsion system.

These figures also show the elevation of the wheel dp with respect to the ground during travel co.

Curve Fv1 shows the evolution of the force applied and curve dp1 that of the elevation of the rolling object wheel.

FIGS. 12 and 13 show the evolution of the force Fv1 applied and the evolution of the elevation of the rolling object wheel for two embodiments of combined and simultaneous gripping and lifting means according to the invention.

FIG. 12 illustrates the case of a system according to the invention with a single tilt element, and FIG. 13 illustrates the case of a system according to the invention with a tilt element and a device for limiting the angular clearance of the tilt element. The system of FIG. 12 corresponds to the embodiment of FIG. 6, the system of FIG. 13 to the embodiment of FIG. 7.

These figures correspond to the gripping and lifting of a rolling object with a weight of approximately 400 N, i.e. substantially 100 N per wheel (for a four-wheeled rolling object). It is noted that, for both systems, the elevation of the wheel is approximately 40 mm, which provides a sufficient ground clearance once the system coupled to the rolling object.

Besides, it is observed that the addition of the angular clearance limiting device between FIG. 12 and FIG. 13 allows to considerably reduce the maximum force required (that decreases from over 200 N to less than 120 N). In FIG. 13, the maximum force corresponds to the instant when the tilter loses contact with the angular clearance limiting device. In FIG. 12, the maximum force corresponds to the first contact of the wheel with the tilt element.

In FIG. 13, a first part is observed where force Fv1 decreases prior to suddenly increasing, then decreasing again. The time of this sudden increase corresponds to the time when the element loses contact with the angular clearance limiting device, i.e. the

1) A removable electric propulsion system for a rolling object, the propulsion system comprising a chassis provided with at least one wheel driven by an electric machine, at least one non-driven wheel and at least one means for coupling the electric propulsion system to the rolling object, characterized in that the coupling means comprises at least one means for combined and simultaneous gripping and lifting at least one wheel of the rolling object, and in that the combined and simultaneous gripping and lifting means comprises a frame, at least one arm extendable in a longitudinal direction and connected to frame, at least one tilt element and at least one push device, one among tilt element and push device being connected to the extendable arm and the other to frame, the push device being capable of driving at least one wheel of rolling object along the longitudinal direction (x) into the at least one tilt element, the tilt element being capable of tilting about an axis of substantially transverse direction.

2) A system as claimed in claim 1, wherein the extendable arm supports at least one of the at least one non-driven wheel.

3) A system as claimed in claim 1, wherein the combined and simultaneous gripping and lifting means comprises at least one device for limiting the angular clearance of at least one tilt element.

4) A system as claimed in claim 1, wherein an approach stop is positioned on the frame or on tilt element.

5) A system as claimed in claim 1, wherein the push device comprises at least one transverse-axis roller fastened to the extendable arm or the frame.

6) A system as claimed in claim 5, wherein the push device comprises a first and a second transverse-axis roller fastened to the extendable arm or the frame, the first roller being configured to contact wheel of rolling object before second roller, the altitude of the axis of first roller being lower than the altitude of the axis of the second roller.

7) A system as claimed in claim 6, wherein the diameter of first roller is less than the diameter of second roller.

8) A system as claimed in claim 1, wherein the coupling means is adjustable in longitudinal position along the chassis.

9) A system as claimed in claim 1, wherein push device comprises two guide pieces (51a, 51b) extending substantially in the longitudinal direction (x), the guide pieces being configured to prevent wheels of rolling object from pivoting.

10) A system as claimed in claim 1, wherein at least one tilt element comprises a means for adjusting the width of the tilt element, the means for adjusting the width of the tilt element being preferably a mobile flange or a shim.

11) A system as claimed in claim 1, wherein electric propulsion system comprises two combined and simultaneous gripping and lifting means, each combined and simultaneous gripping and lifting means being dedicated to a wheel of rolling object, both combined and simultaneous gripping and lifting means being mobile in transverse translation with respect to one another.

12) A system as claimed in claim 1, wherein the frame is connected to the chassis by a sliding connection of transverse direction, preferably by an actuator.

13) A system as claimed in claim 1, wherein the combined and simultaneous gripping and lifting means comprises a raising device configured to ensure a ground clearance greater than a predetermined height in raised position, preferably the predetermined height ranges between 30 mm and 50 mm, and it is more preferably close to 40 mm.

14) A system as claimed in claim 13, wherein the raising device comprises at least one return spring and/or at least one counterweight and/or at least one driven rod.

15) A system as claimed in claim 1, wherein a stop is positioned on the frame or on the extendable arm to provide contact of tilt element in raised position.

16) A coupled assembly comprising a rolling object, preferably a rolling object comprising at least one non-orientable wheel, and an electric propulsion system as claimed in claim 1, rolling object being coupled to electric propulsion system by coupling means.

17) A method for coupling a rolling object to electric propulsion system as claimed in claim 1, comprising the following steps:
a) moving electric propulsion system so as to bring it close to at least one wheel of rolling object,
b) lengthening extendable arm so as to enable positioning of the at least one wheel of rolling object between tilt element and push device,
c) moving electric propulsion system in such a way that the at least one wheel of rolling object is positioned between tilt element and push device,
d) shortening extendable arm in such a way that push device or tilt element contacts the at least one wheel of the rolling object,
e) continuing shortening extendable arm in such a way that push device drives the at least one wheel of rolling object into tilt element.

18) A method as claimed in claim 17 for coupling a rolling object to electric propulsion system, the electric propulsion system comprising two combined and simultaneous gripping and lifting means, the method comprising the following steps:
a) moving electric propulsion system so as to bring it close to two wheels of rolling object,
b) moving transversely at least one of the two combined and simultaneous gripping and lifting means with respect to the other combined and simultaneous gripping and lifting means,
c) lengthening extendable arm of each combined and simultaneous gripping and lifting means so that the space between tilt element and push device allows passage of wheel of rolling object,
d) moving transversely at least one of the two combined and simultaneous gripping and lifting means with respect to the other combined and simultaneous gripping and lifting means, in the opposite direction to step b), until each wheel of rolling object is positioned between a push device and a tilt element,
e) shortening extendable arms so as to drive each wheel of rolling object into each tilt element by means of push device.
